(19) United States
(12) Patent Application Publication
(10) Pub. No.: US 2009/0073853 A1
(43) Pub. Date: Mar. 19, 2009

(54) OPTICAL PICKUP AND DISC DRIVE APPARATUS

(75) Inventor: Hiroshi ISOBE, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/184,629

(22) Filed: Aug. 1, 2008

(30) Foreign Application Priority Data
Sep. 14, 2007 (JP) 2007-239359

(51) Int. Cl. G11B 7/00

(52) U.S. Cl. 369/112.23

(57) ABSTRACT

An optical pickup includes a movable base and an objective lens driving mechanism mounted on the movable base. The objective lens driving mechanism includes a fixed block affixed to the movable base; a movable block having an objective lens and a lens holder holding the objective lens, the movable block moving in focusing, tracking, and tilting directions; supporting springs connecting the fixed block and the movable block; a focusing magnetic circuit including a focusing coil and a focusing magnet; a tracking magnetic circuit including a tracking coil and a tracking magnet; and a tilting magnetic circuit including a tilting coil and a tilting magnet. The lens holder includes a body holding the objective lens, and a thin segment projecting from the body and serving as a dynamic damper that absorbs vibration occurring in the movable block. The tilting coil or the tilting magnet is attached to the thin segment.

### CROSS REFERENCES TO RELATED APPLICATIONS

The present invention contains subject matter related to Japanese Patent Application JP 2007-239359 filed in the Japanese Patent Office on Sep. 14, 2007, the entire contents of which are incorporated herein by reference.

### BACKGROUND OF THE INVENTION

1. Field of the Invention

The present invention relates to optical pickups and disc drive apparatuses. In particular, the present invention relates to a technical field in which satisfactory servo characteristics are ensured during focusing and tracking while functional deterioration is prevented by providing a thin segment serving as a dynamic damper with a movable block.

2. Description of the Related Art

Disc drive apparatuses perform recording and reproduction of information signals onto and from disc recording media such as optical discs and magneto-optical discs. Such a disc drive apparatus includes an optical pickup that is moved in the radial direction of a disc recording medium and emits laser light to the disc recording medium.

Optical pickups include objective lens driving mechanisms. An objective lens driving mechanism includes a fixed block and a movable block. The movable block is supported by the fixed block with the aid of a supporting spring such as a metal wire.

In such an optical pickup, focus adjustment is performed by moving the movable block having an objective lens relative to the fixed block in a focusing direction, which is a direction toward or away from the recording surface of the disc recording medium, while tracking adjustment is performed by moving the movable block relative to the fixed block in a tracking direction, which is a substantially radial direction of the disc recording medium, so that the spot of laser light emitted through the objective lens to the disc recording medium is made to converge on a recording track of the disc recording medium.

Some optical pickups are capable of tilt adjustment. In the tilt adjustment, the movable block is moved relative to the fixed block in the rotational direction of an axis extending in a tangential direction, which is a direction orthogonal to both the focusing direction and the tracking direction, so that the optical axis of the laser light emitted through the objective lens to the recording surface of the disc recording medium becomes perpendicular to the recording surface.

The objective lens driving mechanism included in such an optical pickup has a frequency characteristic (see FIG. 5) defined by the weight of the movable block and the elastic modulus of the supporting spring. Referring to FIG. 5, the objective lens driving mechanism has a resonance peak P in a certain frequency range. Because of this resonance peak P, characteristics of focusing servo and tracking servo may be deteriorated and operational reliability of the disc drive apparatus may be reduced.

Japanese Unexamined Patent Application Publication No. 2004-171679 discloses an exemplary optical pickup capable of preventing deterioration in focusing and tracking servo characteristics caused by occurrence of a resonance peak. In this optical pickup, a coil serving as a weight is attached to a lens holder with a viscoelastic adhesive, whereby a damper is configured.

By configuring a damper using a coil serving as a weight attached to a lens holder with a viscoelastic adhesive, vibration occurring in the lens holder is absorbed by the damper. This reduces the resonance peak. Consequently, satisfactory focusing and tracking servo characteristics are ensured.

### SUMMARY OF THE INVENTION

The optical pickup disclosed in Japanese Unexamined Patent Application Publication No. 2004-171679 has a problem in that performance of the damper, which is configured using a viscoelastic adhesive, tends to be deteriorated during use at high temperature and after a long period of use because the viscoelastic adhesive is not sufficiently resistant to heat and its physical properties often change over time.

Moreover, the viscoelastic adhesive sometimes releases a volatile substance. If the released volatile substance adheres to the objective lens, the optical performance of the optical pickup may be deteriorated.

It is desirable that an optical pickup and a disc drive apparatus according to embodiments of the present invention overcome the problems described above and ensures satisfactory servo characteristics without deterioration of performance.

According to embodiments of the present invention, there are provided an optical pickup and a disc drive apparatus wherein an objective lens driving mechanism includes the following elements: a fixed block affixed to a movable base; a movable block having an objective lens and a lens holder holding the objective lens, the movable block being configured to be moved relative to the fixed block in a focusing direction, which is a direction toward or away from a recording surface of a disc recording medium, in a tracking direction, which is a substantially radial direction of the disc recording medium, and in a tilting direction, which is a rotational direction of an axis extending in a direction orthogonal to both the focusing direction and the tracking direction; a plurality of supporting springs connecting the fixed block and the movable block; a focusing magnetic circuit configured to cause the movable block to move in the focusing direction and including a focusing coil and a focusing magnet; a tracking magnetic circuit configured to cause the movable block to move in the tracking direction and including a tracking coil and a tracking magnet; and a tilting magnetic circuit configured to cause the movable block to move in the tilting direction and including a tilting coil and a tilting magnet. The lens holder includes a body holding the objective lens, and a thin segment projecting from the body and serving as a dynamic damper that absorbs vibration occurring in the movable block. One of the tilting coil and the tilting magnet is attached to the thin segment.

Thus, in the optical pickup and the disc drive apparatus, vibration occurring in the lens holder is absorbed by the thin segment serving as a dynamic damper.

According to an embodiment of the present invention, there is provided an optical pickup configured to irradiate a disc recording medium loaded on a disc table with laser light. The optical pickup includes a movable base configured to be moved in a radial direction of the disc recording medium loaded on the disc table, and an objective lens driving mechanism mounted on the movable base. The objective lens driving mechanism includes a fixed block affixed to the movable base; a movable block having an objective lens and a lens holder holding the objective lens, the movable block being configured to be moved relative to the fixed block in a focusing direction, which is a direction toward or away from a recording surface of the disc recording medium, in a tracking direction, which is a substantially radial direction of the disc recording medium, and in a tilting direction, which is a rotational direction of an axis extending in a direction orthogonal to both the focusing direction and the tracking direction; a plurality of supporting springs connecting the fixed block and the movable block; a focusing magnetic circuit configured to cause the movable block to move in the focusing direction and including a focusing coil and a focusing magnet; a tracking magnetic circuit configured to cause the movable block to move in the tracking direction and including a tracking coil and a tracking magnet; and a tilting magnetic circuit configured to cause the movable block to move in the tilting direction and including a tilting coil and a tilting magnet. The lens holder includes a body holding the objective lens, and a thin segment projecting from the body and serving as a dynamic damper that absorbs vibration occurring in the movable block. One of the tilting coil and the tilting magnet is attached to the thin segment.

Thus, the optical pickup is free from functional deterioration such as that observed in the related-art optical pickup, which uses a viscoelastic adhesive, during use at high temperature, after a long period of use, and because of release of a volatile substance. Therefore, satisfactory servo characteristics during focusing and tracking can be ensured.

In the optical pickup according to the above embodiment, the tilting coil may be attached to the thin segment of the lens holder, the focusing coil and the tracking coil may be attached to the body of the lens holder, and the tilting coil may be disposed across the focusing coil and the tracking coil from the objective lens. Thus, the tilting coil and the objective lens are disposed at a distance from each other. In such a configuration, vibration occurring in the tilting coil is not easily transferred to the objective lens. Accordingly, occurrence of vibration in the objective lens can be suppressed.

According to another embodiment of the present invention, a disc drive apparatus includes a disc table on which a disc recording medium is to be loaded, and an optical pickup configured to irradiate the disc recording medium loaded on the disc table with laser light emitted through an objective lens. The optical pickup includes a movable base configured to be moved in a radial direction of the disc recording medium loaded on the disc table, and an objective lens driving mechanism mounted on the movable base. The objective lens driving mechanism includes a fixed block affixed to the movable base; a movable block having an objective lens and a lens holder holding the objective lens, the movable block being configured to be moved relative to the fixed block in a focusing direction, which is a direction toward or away from a recording surface of the disc recording medium, in a tracking direction, which is a substantially radial direction of the disc recording medium, and in a tilting direction, which is a rotational direction of an axis extending in a direction orthogonal to both the focusing direction and the tracking direction; a plurality of supporting springs connecting the fixed block and the movable block; a focusing magnetic circuit configured to cause the movable block to move in the focusing direction and including a focusing coil and a focusing magnet; a tracking magnetic circuit configured to cause the movable block to move in the tracking direction and including a tracking coil and a tracking magnet; and a tilting magnetic circuit configured to cause the movable block to move in the tilting direction and including a tilting coil and a tilting magnet. The lens holder includes a body holding the objective lens, and a thin segment projecting from the body and serving as a dynamic damper that absorbs vibration occurring in the movable block. One of the tilting coil and the tilting magnet is attached to the thin segment.

Thus, the disc drive apparatus including the optical pickup is free from functional deterioration such as that observed in a disc drive apparatus including the related-art optical pickup, which uses a viscoelastic adhesive, during use at high temperature, after a long period of use, and because of release of a volatile substance. Therefore, satisfactory servo characteristics during focusing and tracking can be ensured.

### BRIEF DESCRIPTION OF THE DRAWINGS

FIG. 1 is a schematic perspective view of a disc drive apparatus including an optical pickup according to an embodiment of the present invention;

FIG. 2 is an enlarged perspective view of an objective lens driving mechanism included in the optical pickup according to the embodiment;

FIG. 3 is an enlarged perspective view of a movable block included in the optical pickup according to the embodiment;

FIG. 4 is a graph showing a frequency characteristic of the optical pickup according to the embodiment; and

FIG. 5 is a graph showing a frequency characteristic of a related-art optical pickup.

### DESCRIPTION OF THE PREFERRED EMBODIMENTS

Embodiments of an optical pickup and a disc drive apparatus according to the present invention will now be described with reference to the attached drawings.

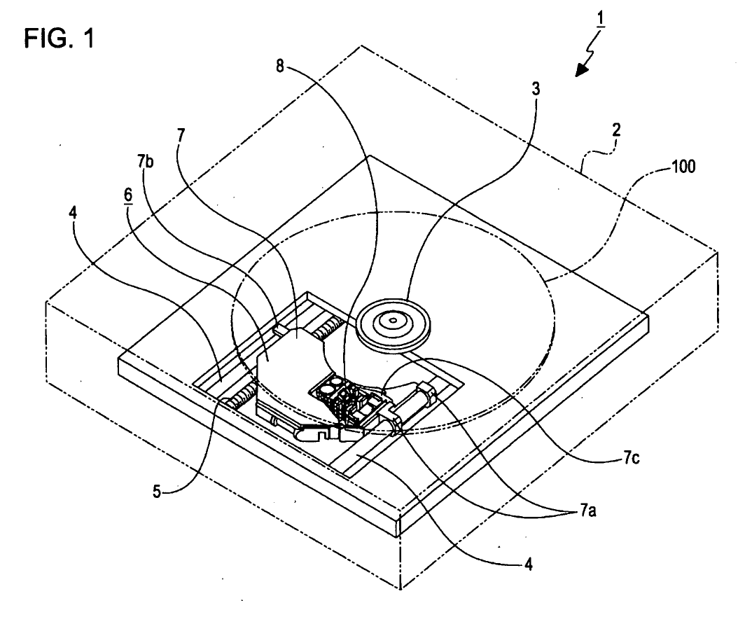

Referring to FIG. 1, a disc drive apparatus 1 has an outer casing 2, which houses relevant components and mechanisms. The outer casing 2 has a disc slot (not shown).

The outer casing 2 also houses a chassis (not shown). The chassis carries a spindle motor. A disc table 3 is secured to a motor shaft of the spindle motor.

The chassis also carries guide shafts 4 and 4, which are parallel to each other, and supports a lead screw 5 that is rotated by a feed motor (not shown).

An optical pickup 6 includes a movable base 7, relevant optical components provided to the movable base 7, and an objective lens driving mechanism 8 mounted on the movable base 7. The movable base 7 is provided at ends thereof with bearings 7a and 7b, with which the movable base 7 is slidably supported by the guide shafts 4 and 4.

A nut member (not shown) provided to the movable base 7 threadably engages the lead screw 5. When the lead screw 5 is rotated by the feed motor, the nut member is moved in a direction according to the rotational direction of the lead screw 5, whereby the optical pickup 6 is moved in a direction along the radius (a radial direction) of a disc recording medium 100 loaded on the disc table 3.

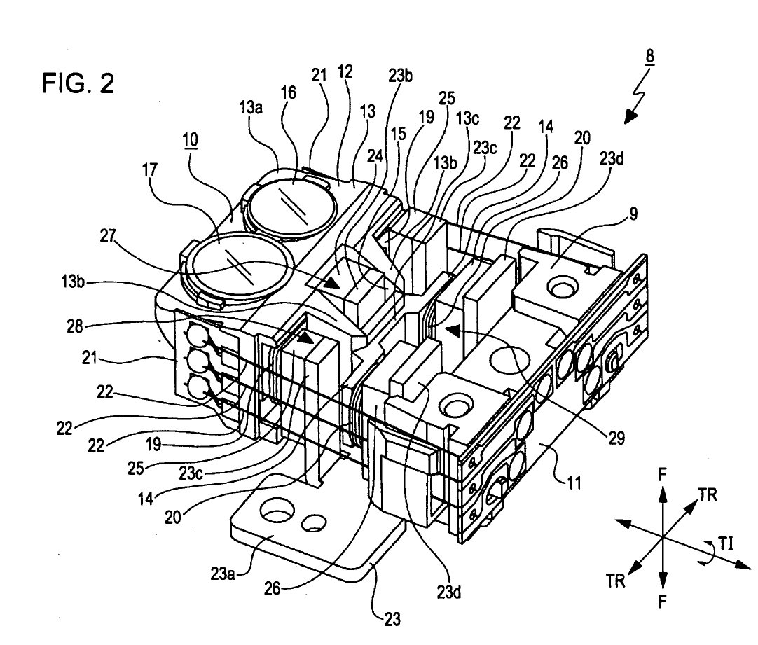

Referring to FIGS. 1 and 2, the objective lens driving mechanism 8 includes a fixed block 9 and a movable block 10. The movable block 10 is moved relative to the fixed block 9. The objective lens driving mechanism 8 is mounted in a mounting recess 7c provided in the movable base 7.

The fixed block 9 and the movable block 10 are spaced apart from each other in a direction of a tangent (a tangential direction) of a recording track of the disc recording medium 100.

The fixed block 9 is affixed to the movable base 7. The fixed block 9 has on the rear surface thereof a circuit board 11.

The movable block 10 is constituted by a lens holder 12 and relevant components mounted thereon.

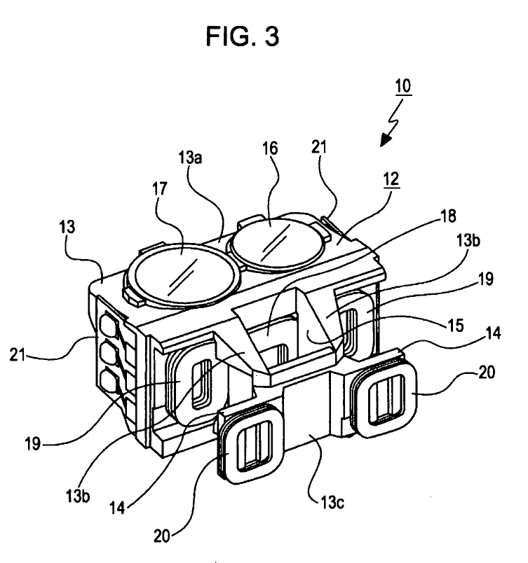

Referring to FIG. 3, the lens holder 12 includes a body 13 and thin segments 14 and 14 projecting from the body 13. The body 13 and the thin segments 14 and 14 are formed as an integral body.

The body 13 includes a lens mounting portion 13a, projecting portions 13b and 13b horizontally spaced apart from each other and projecting rearward from the rear of the lens mounting portion 13a, and a connecting portion 13c connecting the projecting portions 13b and 13b at the rear ends thereof. This configuration of the lens holder 12 provides a positioning space 15 defined by the rear surface of the lens mounting portion 13a, the inner surfaces of the projecting portions 13b and 13b, and the front surface of the connecting portion 13c.

Objective lenses 16 and 17 are mounted atop of and held by the lens mounting portion 13a of the body 13. The objective lenses 16 and 17 are configured for use with disc recording media 100 of different kinds, such as compact discs (CDs) for which laser light having a wavelength of about 780 nm is used, digital versatile discs (DVDs) for which laser light having a wavelength of about 660 nm is used, and Blu-ray Discs for which laser light having a wavelength of about 405 nm is used.

The thin segments 14 and 14 project rightward and leftward, respectively, from the right and left ends of the connecting portion 13c of the body 13, and each have a substantially rectangular plate-like shape with the surfaces thereof facing the front and the rear, respectively. The thin segments 14 and 14 have a thickness of 1 mm or less, for example 0.3 mm, and function as dynamic dampers that absorb vibration occurring in the movable block 10.

In the lens holder 12, the lens mounting portion 13a is provided at the rear surface thereof with a focusing coil 18 and tracking coils 19 and 19. The focusing coil 18 is disposed in the positioning space 15, and the tracking coils 19 and 19 are disposed on the right and left sides, respectively, of the focusing coil 18.

In the lens holder 12, the thin segments 14 and 14 are provided at the respective rear surfaces thereof with tilting coils 20 and 20. Accordingly, the tilting coils 20 and 20 are positioned across the focusing coil 18 and the tracking coils 19 and 19 from the objective lenses 16 and 17.

In the lens holder 12, the lens mounting portion 13a is also provided on the right and left sides thereof with connection boards 21 and 21, respectively. The connection boards 21 and 21 are connected via their connection terminals (not shown) with terminals of the focusing coil 18, the tracking coils 19 and 19, and the tilting coils 20 and 20.

The circuit board 11 mounted on the fixed block 9 and the individual connection boards 21 and 21 mounted on the movable block 10 are connected via three supporting springs 22, the supporting springs 22 each having one end thereof connected to the circuit board 11 and the other end thereof connected to one of the connection boards 21 and 21. Thus, with the supporting springs 22, the movable block 10 is connected to the fixed block 9 while being held in a suspended state.

The supporting springs 22 are made of a conductive metal material and shaped like wires, for example. In the objective lens driving mechanism 8, a driving current is supplied from a power circuit (not shown) via the circuit board 11, the supporting springs 22, and the connection boards 21 and 21 to the focusing coil 18, the tracking coils 19 and 19, or the tilting coils 20 and 20.

The movable base 7 has in the mounting recess 7c thereof a yoke member 23 made of a magnetic metal material.

The yoke member 23 includes a base portion 23a that extends horizontally with the surfaces thereof facing up and down, respectively, a first yoke portion 23b projecting upward from the front end of the base portion 23a, second yoke portions 23c and 23c also projecting upward from the front end of the base portion 23a, and third yoke portions 23d and 23d projecting upward from the rear end of the base portion 23a. The second yoke portions 23c and 23c reside on the right and left sides, respectively, of the first yoke portion 23b. The third yoke portions 23d and 23d are horizontally spaced apart from each other.

The first yoke portion 23b is provided on the front surface thereof with a focusing magnet 24. The second yoke portions 23c and 23c are provided on the front surfaces thereof with tracking magnets 25 and 25, respectively. The third yoke portions 23d and 23d are provided on the front surfaces thereof with tilting magnets 26 and 26, respectively. The first yoke portion 23b and the focusing magnet 24 are fitted into the positioning space 15 from the underside.

The focusing magnet 24 faces the focusing coil 18. The tracking magnets 25 and 25 face the tracking coils 19 and 19, respectively. The tilting magnets 26 and 26 face the tilting coils 20 and 20, respectively.

The focusing coil 18, the focusing magnet 24, and the first yoke portion 23b constitute a focusing magnetic circuit 27. The tracking coils 19 and 19, the tracking magnets 25 and 25, and the second yoke portions 23c and 23c constitute a tracking magnetic circuit 28. The tilting coils 20 and 20, the tilting magnets 26 and 26, and the third yoke portions 23d and 23d constitute a tilting magnetic circuit 29.

Supply of a driving current from the power circuit (not shown) to the focusing coil 18, the tracking coils 19 and 19, or the tilting coils 20 and 20 produces a force in a direction that depends on the direction of the driving current and the direction of magnetic fluxes generated by the focusing magnet 24, the tracking magnets 25 and 25, or the tilting magnets 26 and 26. Thus, the movable block 10 is moved in a focusing, tracking, or tilting direction.

The focusing direction is a direction toward or away from the disc recording medium 100 (a direction F in FIG. 2), i.e., the vertical direction. The tracking direction is the radial direction of the disc recording medium 100 (a direction TR in FIG. 2), i.e., a horizontal direction. The tilting direction is the rotational direction (a direction TI in FIG. 2) of an axis extending in a direction orthogonal to both the focusing direction and the tracking direction (a tangential direction).

When the movable block 10 is moved in the focusing, tracking, or tilting direction, the supporting springs 22 elastically deform.

In the disc drive apparatus 1 configured as described above, when the disc table 3 is spun by the rotation of the spindle motor, the disc recording medium 100 loaded on the disc table 3 is spun. At the same time, the optical pickup 6 is moved in the radial direction of the disc recording medium 100, whereby recording or reproduction of information onto or from the disc recording medium 100 is performed.

When a driving current is supplied to the focusing coil 18 during recording or reproduction, the movable block 10 of the objective lens driving mechanism 8 is moved relative to the fixed block 9 in the focusing direction F-F shown in FIG. 2, as described above. Thus, focus adjustment is performed such that the spot of laser light emitted through the objective lens 16 or 17 is made to converge on the recording surface of the disc recording medium 100.

When a driving current is supplied to the tracking coils 19 and 19, the movable block 10 of the objective lens driving mechanism 8 is moved relative to the fixed block 9 in the tracking direction TR-TR shown in FIG. 2, as described above. Thus, tracking adjustment is performed such that the spot of laser light emitted through the objective lens 16 or 17 is made to converge on a recording track of the disc recording medium 100.

When a driving current is supplied to the tilting coils 20 and 20, the movable block 10 of the objective lens driving mechanism 8 is moved relative to the fixed block 9 in the tilting direction TI-TI shown in FIG. 2, as described above. Thus, tilt adjustment is performed such that the optical axis of laser light emitted through the objective lens 16 or 17 becomes perpendicular to the recording surface of the disc recording medium 100.

In the optical pickup 6, the movable block 10 tends to vibrate during focusing and tracking, while the tilting coils 20 and 20 provided on the thin segments 14 and 14 function as weights. Thus, the thin segments 14 and 14 function as dynamic dampers. Specifically, as the body 13 vibrates during focusing and tracking, the thin segments 14 and 14 vibrate with a period different from the period of the vibration occurring in the body 13, the period depending on the elastic modulus and weight specific to the thin segments 14 and 14. Therefore, a resonance peak at a resonance frequency that deteriorates servo characteristics is reduced during focusing and tracking. Accordingly, satisfactory focusing and tracking servo characteristics can be ensured.

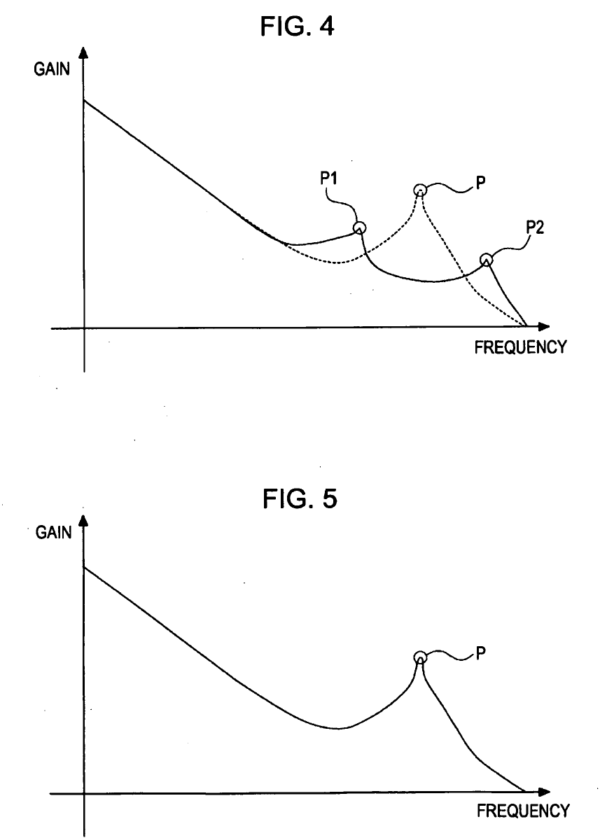

FIG. 4 is a graph showing frequency characteristics in focusing and tracking. The solid line shows the frequency characteristic of the optical pickup 6, and the broken line shows the frequency characteristic of a related-art optical pickup shown in FIG. 5. Referring to FIG. 4, the optical pickup 6 has resonance peaks (P1 and P2) in two specific ranges of the resonance frequency. The resonance peaks P1 and P2 are both smaller than a resonance peak P in the related-art optical pickup.

In the related-art optical pickup, which uses a viscoelastic adhesive, functional deterioration often occurs during use at high temperature, after a long period of use, and because of release of a volatile substance. However, the optical pickup 6, which includes as a part of the lens holder 12 the thin segments 14 and 14 serving as dynamic dampers as described above, is free from functional deterioration such as that observed in the related-art optical pickup. Therefore, the optical pickup 6 can ensure satisfactory servo characteristics in focusing and tracking.

In the optical pickup 6, which is capable of reducing the resonance peak, the movable block 10 can be made to follow a high-frequency vibration during focusing and tracking. Accordingly, the optical pickup 6 can realize a high-gain servo operation and consequently can cope with a high speed operation.

On the other hand, the optical pickup 6 has a reduced transfer characteristic between the tilting coils 20 and 20 and the objective lenses 16 and 17 during tilting because of existence of the tilting coils 20 and 20 provided to the thin segments 14 and 14. However, the reduced transfer characteristic does not lead to deterioration in performance of the objective lens driving mechanism 8. This is because, while focusing and tracking are performed on the basis of a servo operation using a feedback circuit and therefore the resonance peak is desired to be reduced so as to improve operational reliability, tilting is not performed on the basis of such a servo operation but is performed on the basis of a feedforward operation in accordance with a target value.

In the optical pickup 6, the tilting coils 20 and 20 and the objective lenses 16 and 17 are disposed at a distance from each other with the focusing coil 18 and the tracking coils 19 and 19 interposed therebetween. In such a configuration, vibration occurring in the tilting coils 20 and 20 is not easily transferred to the objective lenses 16 and 17. Accordingly, occurrence of vibration in the objective lenses 16 and 17 can be suppressed.

The foregoing description concerns an exemplary objective lens driving mechanism 8 of a so-called moving-coil type in which the focusing coil 18, the tracking coils 19 and 19, and the tilting coils 20 and 20 are attached to the lens holder 12. Alternatively, an objective lens driving mechanism of a so-called moving-magnet type may be used in which the focusing magnet 24, the tracking magnets 25 and 25, and the tilting magnets 26 and 26 are attached to the lens holder 12.

The objective lens driving mechanism 8 taken as an example in the foregoing description includes one focusing coil, two tracking coils, two tilting coils, one focusing magnet, two tracking magnets, and two tilting magnets. However the numbers of coils and magnets are not limited to one or two, and any numbers of coils and magnets may be provided when applying the present invention.

The foregoing description concerns an example in which two thin segments 14 and 14 are provided as dynamic dampers. However, the number of thin segments is not limited to two, and any number of thin segments may be provided when applying the present invention.

In the foregoing description, the focusing direction, the tracking direction, and the tangential direction correspond to the vertical direction, the horizontal direction, and the front-rear direction, respectively. However, these directional expressions are only provided as a matter of convenience and are not limited to such directions.

The shapes and configurations of the components specifically described above are only for exemplary embodiments of the present invention and do not limit the scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup configured to irradiate a disc recording medium loaded on a disc table with laser light, the optical pickup comprising:
a movable base configured to be moved in a radial direction of the disc recording medium loaded on the disc table; and
an objective lens driving mechanism mounted on the movable base,
wherein the objective lens driving mechanism includes
a fixed block affixed to the movable base;
a movable block having an objective lens and a lens holder holding the objective lens, the movable block being configured to be moved relative to the fixed block in a focusing direction, which is a direction toward or away from a recording surface of the disc recording medium, in a tracking direction, which is a substantially radial direction of the disc recording medium, and in a tilting direction, which is a rotational direction of an axis extending in a direction orthogonal to both the focusing direction and the tracking direction;
a plurality of supporting springs connecting the fixed block and the movable block;
a focusing magnetic circuit configured to cause the movable block to move in the focusing direction and including a focusing coil and a focusing magnet;
a tracking magnetic circuit configured to cause the movable block to move in the tracking direction and including a tracking coil and a tracking magnet; and
a tilting magnetic circuit configured to cause the movable block to move in the tilting direction and including a tilting coil and a tilting magnet,
wherein the lens holder includes
a body holding the objective lens; and
a thin segment projecting from the body and serving as a dynamic damper that absorbs vibration occurring in the movable block, and
wherein one of the tilting coil and the tilting magnet is attached to the thin segment.

2. The optical pickup according to claim 1,
wherein the tilting coil is attached to the thin segment of the lens holder,
wherein the focusing coil and the tracking coil are attached to the body of the lens holder, and
wherein the tilting coil is disposed across the focusing coil and the tracking coil from the objective lens.

3. A disc drive apparatus, comprising:
a disc table on which a disc recording medium is to be loaded; and
an optical pickup configured to irradiate the disc recording medium loaded on the disc table with laser light emitted through an objective lens,
wherein the optical pickup includes
a movable base configured to be moved in a radial direction of the disc recording medium loaded on the disc table; and
an objective lens driving mechanism mounted on the movable base,
wherein the objective lens driving mechanism includes
a fixed block affixed to the movable base;
a movable block having an objective lens and a lens holder holding the objective lens, the movable block being configured to be moved relative to the fixed block in a focusing direction, which is a direction toward or away from a recording surface of the disc recording medium, in a tracking direction, which is a substantially radial direction of the disc recording medium, and in a tilting direction, which is a rotational direction of an axis extending in a direction orthogonal to both the focusing direction and the tracking direction;
a plurality of supporting springs connecting the fixed block and the movable block;
a focusing magnetic circuit configured to cause the movable block to move in the focusing direction and including a focusing coil and a focusing magnet;
a tracking magnetic circuit configured to cause the movable block to move in the tracking direction and including a tracking coil and a tracking magnet; and
a tilting magnetic circuit configured to cause the movable block to move in the tilting direction and including a tilting coil and a tilting magnet,
wherein the lens holder includes
a body holding the objective lens; and
a thin segment projecting from the body and serving as a dynamic damper that absorbs vibration occurring in the movable block, and
wherein one of the tilting coil and the tilting magnet is attached to the thin segment.
